(19) United States
(12) Patent Application Publication
(10) Pub. No.: US 2010/0299078 A1
(43) Pub. Date: Nov. 25, 2010

(54) CHROMATOGRAPHY DATA PROCESSING METHOD AND SYSTEM

(76) Inventor: Paul Guieze, Fontenailles (FR)

Correspondence Address: SCHLUMBERGER OILFIELD SERVICES, 200 GILLINGHAM LANE, MD 200-9, SUGAR LAND, TX, 77478, US

(21) Appl. No.: 12/682,867

(22) PCT Filed: Oct. 30, 2008
(86) PCT No.: PCT/US08/81752

§ 371 Date: Jun. 11, 2010

Related U.S. Application Data
(60) Provisional application No. 60/983,889, filed on Oct. 30, 2007.

(51) Int. Cl. G06F 19/00; G01N 31/00; G06F 15/18

(52) U.S. Cl. 702/24; 706/16

(57) ABSTRACT

A configurable scanner (1), adapted for contactless measurement of the depth and perimeter of a wound on a target body part (9), has a scan head (4), and a processor (3) for controlling a scanning procedure and analyzing the results. The scan head is translated along a substantially semicircular path (7) having a configurable radial distance from an imaginary axis, such that the imaginary axis is approximately coincident with an axis of the target (9). The scan head (4) projects a contour line having a calibrated length onto the target surface, and the processor (3) stores an image of the projected contour line captured by an image capturing device (11). The processor (3) analyzes a series of captured images to determine the coordinates in three axes of the projected contour line, creates therefrom a 3D model of the region of interest, and determines a depth and perimeter of the wound from the 3D model.

### CROSS REFERENCE TO RELATED DOCUMENTS

The present invention claims benefit of priority to U.S. Provisional Patent Application Ser. No. 60/983,889 of Paul GUIEZE, entitled “CHROMATOGRAPHY DATA PROCESSING METHOD,” filed on Oct. 30, 2007, the entire contents of which are hereby incorporated by reference herein.

### BACKGROUND OF THE INVENTION

1. Field of the Invention

The present invention generally relates to chromatography data processing systems and methods, and more particularly to a chromatography data processing system and method used with a fluid analyzer to determine fluid composition for a specified fluid analysis type.

2. Discussion of the Background

In recent years, a variety of methods have been employed to process fluid chromatography data in order to determine the composition of a fluid sample, i.e., the fluid components constituting the sample. The fluid sample can be a gas or a liquid sample. The fluid sample is analyzed using a fluid chromatograph, or fluid analyzer 1, as shown in FIG. 1. A typical fluid analyzer 1 includes an injector 3, at least one separation column 5, a detector 7, and a data processing system 9. FIG. 2 shows a typical chromatogram 11. The chromatography data (i.e., the signal) coming from a fluid analyzer using fluid chromatography includes a set of signal values 13 as a function of time 15. The time 15 is a retention time of the fluid components within a separation column of the fluid analyzer. The signal values 13 may show several local maxima or fluid component peaks 17 that correspond to specific components of the fluid sample. The peaks 17 may also be detection noise or other spikes that do not correspond to fluid components. Within the signal values 13 can be determined a baseline 19 that corresponds to the signal that would be measured when no fluid sample is in the fluid analyzer, i.e., only a carrier material is eluting. The areas of the fluid component peaks give information about the concentration of corresponding fluid components within the fluid sample that is analyzed.

The type of signal values 13 depends on the type of the employed detector of the fluid analyzer, and which exploits a specific physical or chemical property of the fluid components. For example, a thermal conductivity detector measures the thermal conductivity of components of a fluid sample having a different thermal conductivity than that of a carrier material that carries the fluid sample through the fluid analyzer.

Still referring to FIG. 2, the signal values 13 may include one or more resolved fluid component peaks 21 and unresolved fluid component peaks 23. Unresolved fluid component peaks 23 may appear when two or more fluid components of the fluid sample have a very similar retention time in the separation column and are not fully separated by the chromatography method. In addition, noise and spikes may be present in the signal values 13.

Referring now to FIG. 3, two background art examples of peak splitting methods are illustrated. FIG. 3a shows splitting two unresolved fluid component peaks 23 by vertical projection from the valley between the two peaks to the baseline 19. From that, two resolved fluid component peaks can be reconstituted. In FIG. 3b, it is supposed that a smaller peak is superposed on an edge of a larger peak. The method used for separating the smaller from the larger peak is tangential skimming, i.e., a tangential baseline 25 is laid from the valley between the two unresolved peaks 23 to a point where the baseline 19 intersects the unresolved peaks at the edge where the smaller peak is situated. Thus, these methods lead only to an approximate peak separation, and the retention times and quantities of the corresponding fluid component are not correctly evaluated.

Further, the fluid component peaks are identified, i.e., the name of a component (e.g., nitrogen, carbon dioxide, etc.) is attributed to each fluid component peak. The identification is carried out using the retention times of the fluid component, each component corresponding to a specific retention time. A reference analysis is often used for comparison. The retention time of a specific fluid component may vary from one analysis to another because of separation column aging, varying analysis conditions (e.g., temperature, or carrier fluid velocity), etc.

### SUMMARY OF THE INVENTION

Thus, the prior methods discussed above lead only to an approximate peak separation, and the retention times and quantities of the corresponding fluid component or components are not correctly evaluated. The present invention includes the recognition that an unambiguous identification of the fluid components is not always possible, and the chromatography data have to be post-processed by the user, or the user has to intervene during the time the chromatography data are being processed.

The above and other needs and problems are addressed by the present invention, which in first aspects, provides a method and computer program product for treating fluid chromatography data of a specified fluid analysis type, including receiving the fluid chromatography data of a fluid sample including at least one fluid component of the specified fluid analysis type from a detector of a fluid analyzer, the fluid chromatography data comprising signal values as a function of time, and processing the received fluid chromatography data. The processing includes detecting at least one fluid component peak within the signal values for obtaining at least one retention time corresponding to the at least one detected fluid component peak, identifying the at least one fluid component corresponding to the at least one detected retention time using shape recognition through an artificial neural network preliminarily trained for identifying fluid component peaks of fluid chromatography data of the specified fluid analysis type, integrating the at least one detected fluid component peak to determine a quantity of the at least one fluid component detected by the detector of the fluid analyzer, and calculating a fluid sample composition from the at least one identified fluid component and the quantities of the at least one identified fluid component.

In one embodiment of the first aspect, the processing step further includes defining a baseline within the signal values. In another embodiment of the first aspect, the baseline is defined using shape recognition through the artificial neural network. In yet another embodiment of the first aspect, the integrating step comprises deconvoluting at least one unresolved fluid component peak. In a further embodiment of the first aspect, the detecting step includes detecting a peak start on the baseline, discriminating the fluid component peaks from other peaks and noise using a threshold value, and detecting a peak crest and a peak end of each fluid component peak. In another embodiment of the first aspect, the deconvoluting step includes calculating a derivative of the at least one unresolved fluid component peak, and comparing the derivative to a derivative of a resolved fluid component peak. In another embodiment of the first aspect, the method of treating fluid chromatography data further includes calibrating the detector of the fluid analyzer. In another embodiment of the first aspect, the method of treating fluid chromatography data further includes reporting the processed fluid chromatography data.

In a second aspect, the invention provides a device for processing fluid chromatography data of a fluid sample which includes at least one fluid component of a specified fluid analysis type, the fluid chromatography data including signal values as a function of time, the device including an input to receive the fluid chromatography data from a fluid analyzer, a peak detection module configured to detect at least one fluid component peak within the signal values for obtaining at least one retention time corresponding to the at least one detected fluid component peak, a peak integration module configured to integrate the at least one detected fluid component peak, a fluid component identification module comprising an artificial neural network configured to identify the at least one fluid component corresponding to the at least one detected retention time, the artificial neural network being preliminarily trained for identifying fluid component peaks of fluid chromatography data of the specified fluid analysis type, and a calculation module configured to calculate a fluid sample composition.

In an embodiment of the second aspect, the device further includes a baseline definition module configured to define a baseline within the signal values. In another embodiment of the second aspect, the peak integration module includes a peak deconvolution module configured to deconvolute unresolved fluid component peaks.

In a third aspect, the invention provides a system for treating fluid chromatography data of a specified fluid analysis type, the system including a fluid analyzer including an injector, at least one separation column, and a detector, and the device for processing fluid chromatography data according to the second aspect of the invention.

In one embodiment of the third aspect, the system further includes a calibration module configured to calibrate the detector of the fluid analyzer. In another preferred embodiment of the third aspect, the system further includes a reporting module configured to report the processed fluid chromatography data.

In fourth aspects, the invention provides a training method and computer program product for an artificial neural network for fluid component identification for processing fluid chromatography data of a fluid sample of a specified fluid analysis type, the artificial neural network comprising a set of weights to be optimized, the training method including preparing a set of training chromatography data of at least one fluid sample having at least one determined component of the specified fluid analysis type, the training chromatography data comprising signal values as a function of time, creating at least one input vector of selected time values for the set of training chromatography data, and inputting the at least one input vector into the artificial neural network to calculate the optimized set of weights corresponding to the specified fluid analysis type.

In a further embodiment of the fourth aspect, the selected time values correspond to fluid component peak crest signal values.

Still other aspects, features, and advantages of the present invention are readily apparent from the entire description thereof, including the figures, which illustrate a number of exemplary embodiments and implementations. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 shows a schematic of a background art fluid chromatograph system;

FIG. 2 shows a typical chromatogram;

FIGS. 3a and 3b show examples of splitting unresolved fluid component peaks;

FIG. 4 shows a schematic of a chromatography data processing system in accordance with one or more embodiments of the present invention;

FIG. 5 shows a flowchart of a method of treating fluid chromatography data according to one or more embodiments of the present invention; and

FIG. 6 shows an example of a deconvoluted peak of a chromatogram after applying a peak deconvolution module of a chromatography data processing device according to one or more embodiments of the present invention.

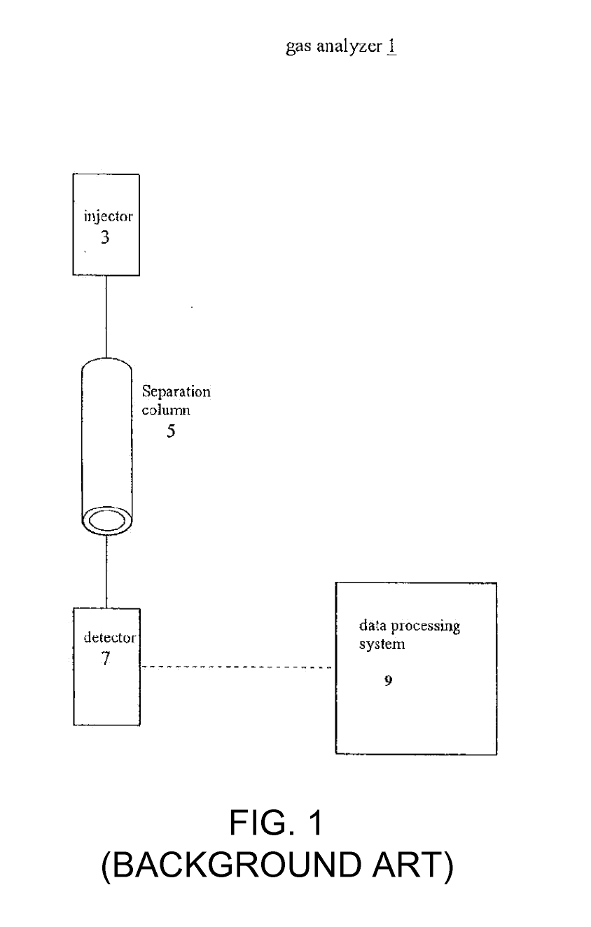

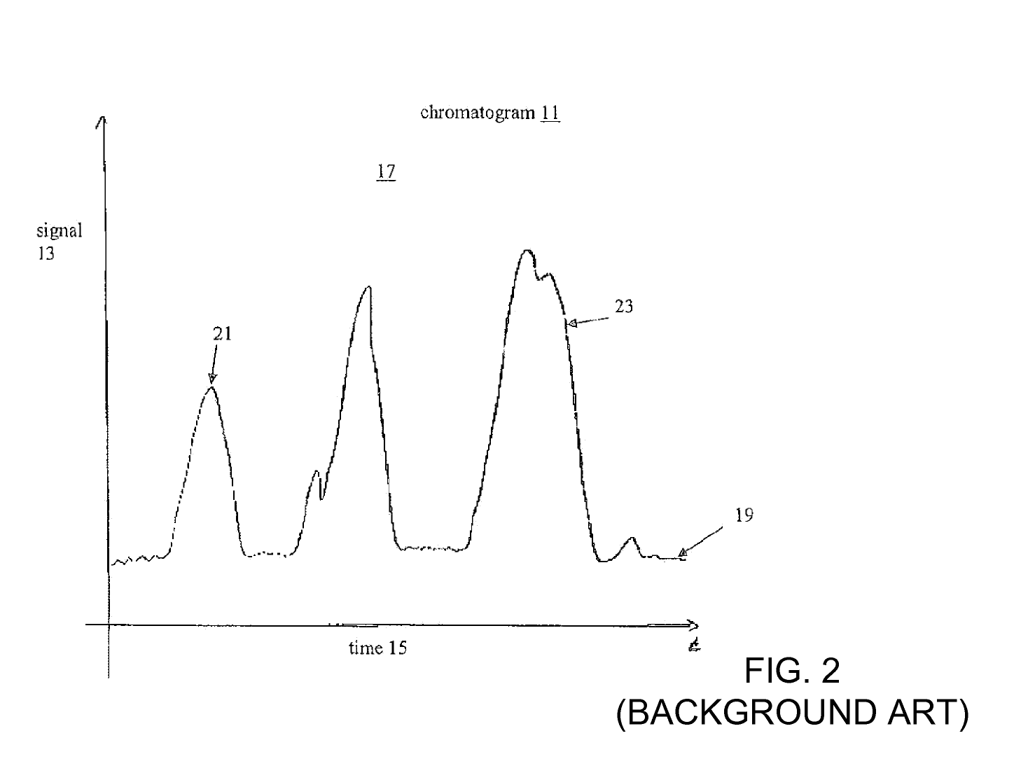

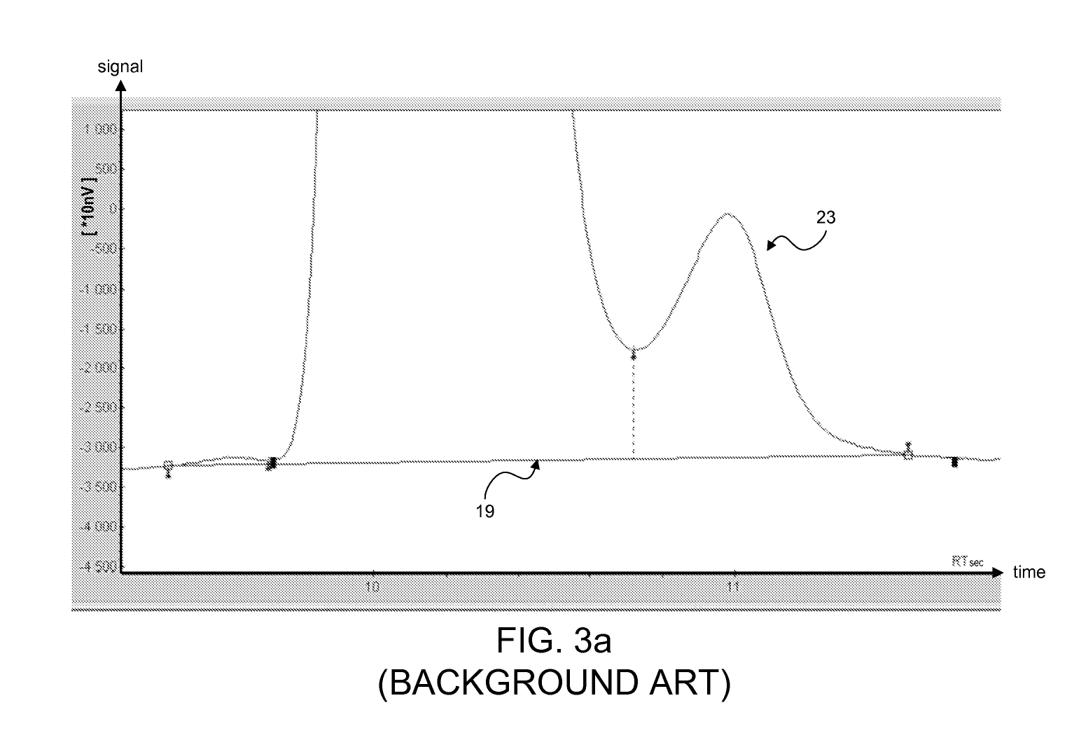

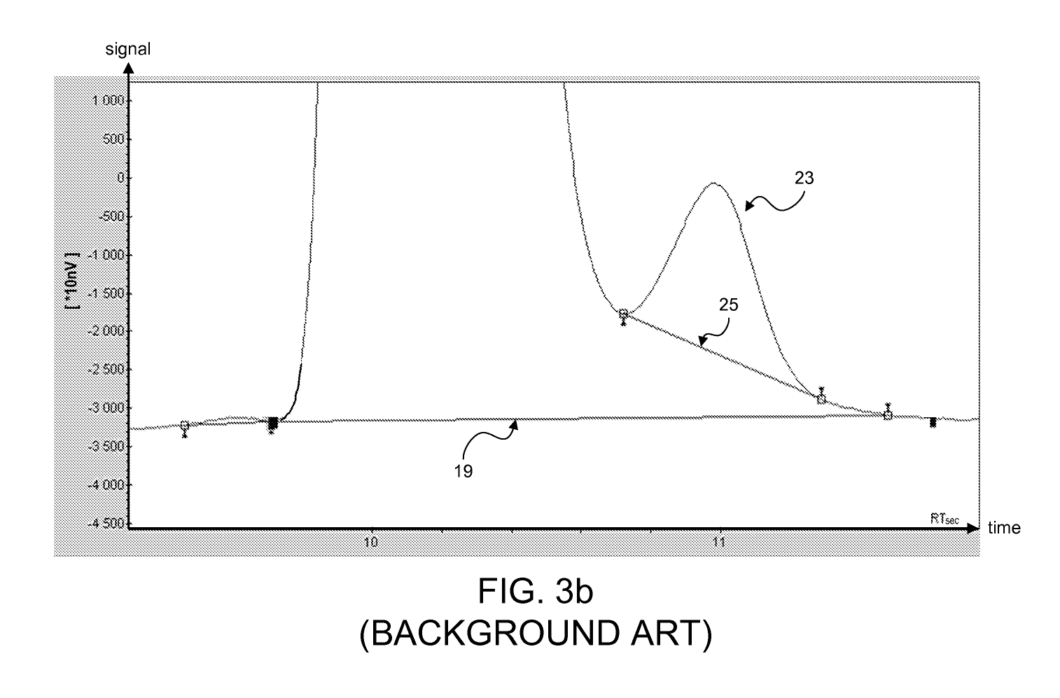

### DETAILED DESCRIPTION

Various embodiments and aspects of the invention will now be described in detail with reference to the accompanying figures. The terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited. Exemplary embodiments of the invention will now be described in detail with reference to the accompanying figures, in which like elements may be denoted by like reference numerals for consistency.

In one aspect, embodiments of the invention relate to a chromatography data processing system used with a fluid analyzer of a specified fluid analysis type to determine a fluid composition of various fluid samples, the fluid chromatography data processing system using an artificial neural network (ANN). The specified fluid analysis type can relate naturally to any suitable type of gas analyses, for example, in the oilfield (e.g., in bottom hole or explosive environments), or in laboratory applications.

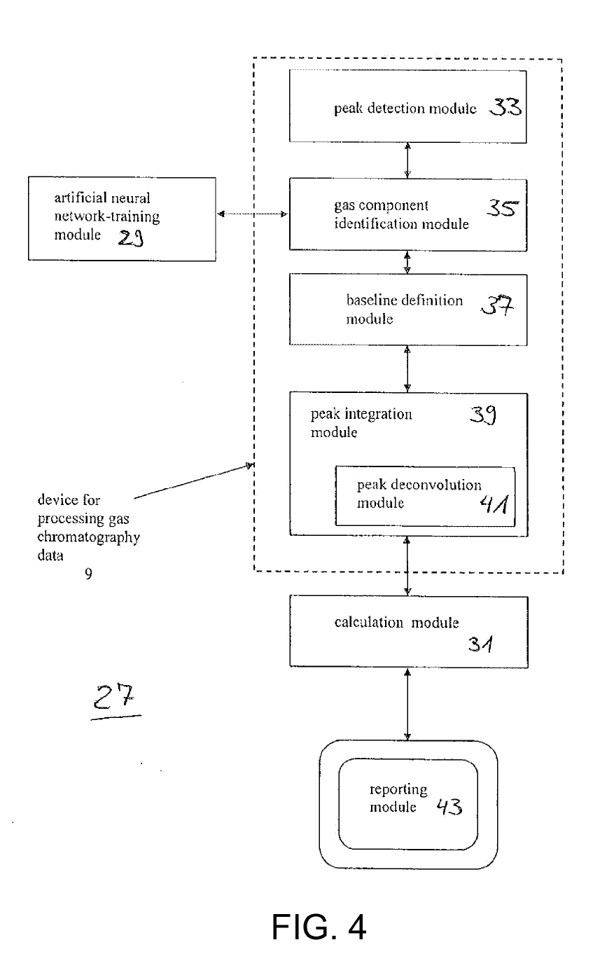

FIG. 4 shows a schematic of a chromatography data treating system 27 in accordance with an embodiment of the present invention. The system 27 includes a chromatography data processing device 9, an artificial neural network-training module 29, and a calculation module 31. The chromatography data processing device 9 includes a peak detection module 33, a fluid component identification module 35 including an artificial neural network, a baseline definition module 37, and a peak integration module 39. In this embodiment, the peak integration module 39 includes a peak deconvolution module 41. The chromatography data treating system 27 further includes a reporting module 43 and a calibration module (not shown). According to embodiments disclosed herein, the chromatography data processing device 9 is configured to process the fluid chromatography data.

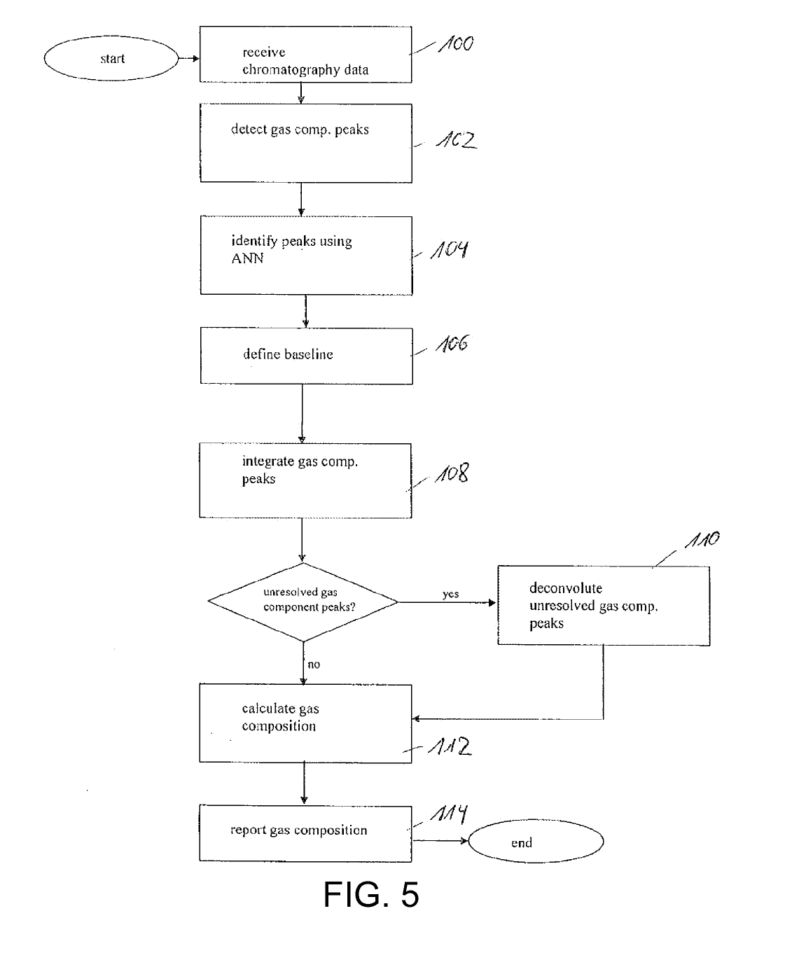

Referring now to FIG. 5, a flowchart is shown that illustrates the steps of the chromatography data treating method according to embodiments of the invention. In one or more embodiments, one or more steps shown in FIG. 5 can be omitted, repeated, and/or performed in a different order than that shown in FIG. 5. Accordingly, the specific arrangement of steps shown in FIG. 5 should not be construed as limiting the scope of the invention.

In FIG. 5, in step 100, the chromatography data are received from the detector of the fluid analyzer. The fluid chromatography data received from the detector includes signal values as a function of time.

In step 102, peaks are detected by the peak detection module within the signal values received from the detector of the fluid chromatograph. Generic noise of the baseline for the current fluid sample analysis is automatically detected. Then, a first threshold value is determined, and only the signal values exceeding the first threshold value are taken into account for peak detection. A second threshold value is used to discriminate spikes from fluid component peaks within the signal values exceeding the first threshold value. This way, the peak start time of the fluid component peaks is detected. The peak start time is the moment when the corresponding fluid component reaches the detector of the fluid analyzer. The peak top time and the peak end time are then detected. The peak end time is the moment when the corresponding fluid component stops arriving at the detector of the fluid analyzer, and the peak top time is the moment when the peak reaches its maximum value.

In step 104, the detected fluid component peaks are identified, e.g., a fluid component corresponding to a specific fluid component peak is identified for each fluid component peak. To this end, the fluid component identification module includes an artificial neural network. The artificial neural network works based on shape recognition. The chromatography data (e.g., the signal values as a function of time) forms a pattern of fluid component peaks, and the artificial neural network is configured to recognize this pattern. The artificial neural network has been trained beforehand (e.g., before the current analysis of a fluid sample) in order to be able to recognize patterns corresponding to specific fluid samples.

In step 106, the baseline of the chromatography data is defined. This can be done by recording a blank analysis, e.g., only a carrier material is eluting through the fluid analyzer, at determined operational conditions (temperature, carrier material, eluting velocity, etc.). Some known points of the baseline can be fed into the system after receiving signal values from the detector when a fluid sample is analyzed. These known points can be, for example, signal values before the first peak, after the last peak, or between peaks (e.g., no fluid components are eluting from the separation column). The baseline can also be defined by using shape recognition through the artificial neural network.

In step 108, the detected fluid component peaks are integrated after subtracting the baseline from the signal values in order to determine the area of the fluid component peaks using the integration module. The area of the fluid component peaks gives information about the quantity of the corresponding components within the sample, e.g., their concentration.

In one embodiment of the invention, unresolved fluid component peaks within the signal values can be detected. This can be done by performing a derivative of the signal. The derivative of the signal at the fluid component peaks is compared to the derivative of a known mono-component peak. Thus, multiple peak tops or shoulders are identified.

If unresolved fluid component peaks are present within the signal values, the detected unresolved fluid component peaks are deconvoluted at step 110 in order to obtain resolved fluid component peaks. Each unresolved fluid component peak is thus split into several resolved fluid component peaks such that the sum of the resolved fluid component peaks is the unresolved fluid component peak. To this end, the peak deconvolution module is implemented with the peak integration module. The deconvolution step can include calculating a derivative of the unresolved peaks, and then comparing the derivative of the unresolved peaks to a derivative of a resolved fluid component peak.

In step 112, the composition (e.g., components and their concentrations) of the analyzed fluid sample according to the processed fluid chromatography data of the specified analysis type is calculated using the calculation module. In addition, average molar mass, heat content, and/or other critical properties can be calculated.

Still referring to FIG. 5, at step 114, the calculated composition of the analyzed fluid sample is reported using the reporting module. The reporting module can also report the processed chromatography data (e.g., retention times, concentrations of fluid components) and/or the signal received from the detector of the fluid analyzer. Specifically, graphic representations of the processed chromatography data, the calculated composition of the fluid sample, and/or the signal received from the detector of the fluid analyzer can be provided. Thereby, a report in any suitable electronic and/or printable form known in the art can be provided.

Returning to FIG. 4, in one embodiment of the invention, the calibration module (not shown) is configured to calibrate the detector of the fluid analyzer. Several fluid samples of known composition are analyzed by the fluid analyzer, and their composition is entered manually or automatically into the chromatography data treating system. Response factors of the detector can then be calculated, whereby the response of the detector (e.g., linear or nonlinear) is taken into account. The calculated response factors are stored in the system.

Still referring to FIG. 4, in one embodiment of the invention, the artificial neural network-training module 29 is configured to train the artificial neural network of the fluid component identification module 35. Under determined experimental conditions (e.g., type of separation column, type of detector, temperature, etc.), a number of analyses (e.g., several tens of analyses) of several similar fluid samples are carried out. The several similar fluid samples have the same fluid components as the fluid sample to be analyzed in the current analysis, whereby the concentrations of the components of the several similar fluid samples are varying in order to cover the range of concentrations of components that is expected for fluid samples to be analyzed. Thus, a number of chromatography data sets are generated. Some time values out of one set of chromatography data (e.g., the retention times corresponding to fluid component peak crests) are then used to create an input vector. The input vector then is processed by the artificial neural network in order to optimize weights of the artificial neural network. Several time vectors can be employed to get optimized weights that satisfy the needs for a specified analysis type.

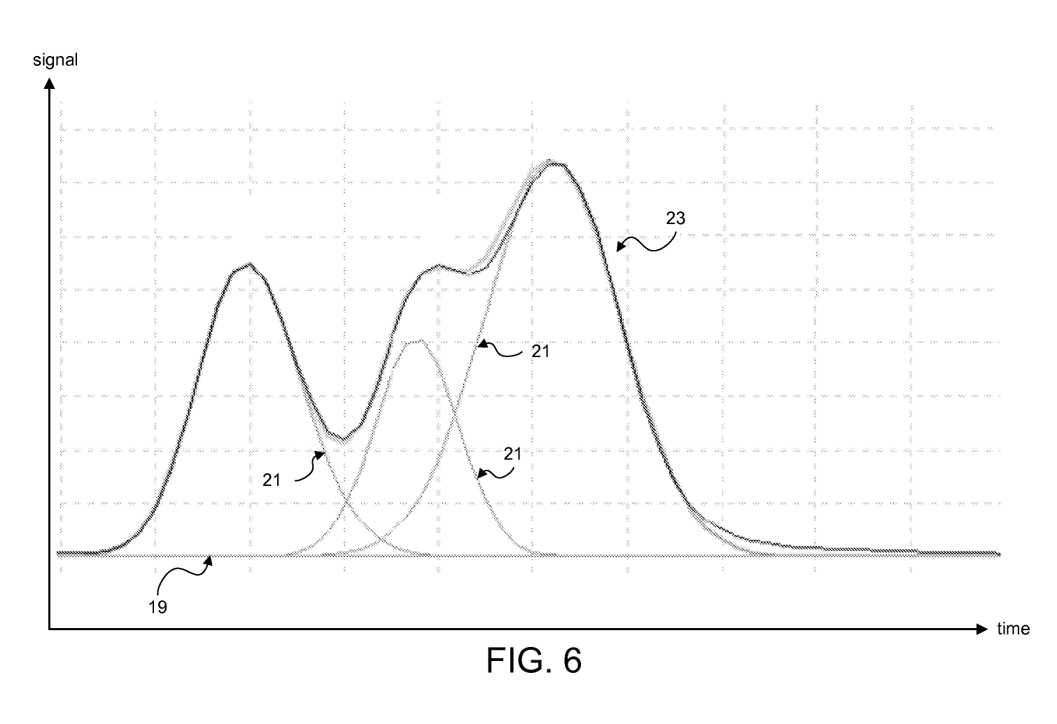

Referring now to FIG. 6, an example is shown of unresolved fluid component peaks 23 that are resolved using the deconvolution module according to an embodiment of the present invention. Advantageously, this allows to precisely compute the area of every single resolved fluid component peak 21 after subtracting the baseline 19.

Embodiments of the invention discussed herein can include one or more of the following advantages. For example, due to the fluid component identification through pattern recognition using an artificial neural network, the fluid chromatography data processing device is insensitive to analysis operation variations, such as temperature fluctuations, flow rate variations, or different types of carrier materials. The fluid component peaks can be identified unambiguously in any relative concentration. Furthermore, the deconvolution step allows the fluid component identification module to correctly evaluate the retention times of the fluid components.

The above-described devices and subsystems of the exemplary embodiments of FIGS. 4-6 can include, for example, any suitable servers, workstations, personal computers (PCs), laptop computers, personal digital assistants (PDAs), Internet appliances, handheld devices, cellular telephones, wireless devices, other electronic devices, and the like, capable of performing the processes of the exemplary embodiments of FIGS. 4-6. The devices and subsystems of the exemplary embodiments of FIGS. 4-6 can communicate with each other using any suitable protocol and can be implemented using one or more programmed computer systems or devices.

One or more interface mechanisms can be used with the exemplary embodiments of FIGS. 4-6, including, for example, Internet access, telecommunications in any suitable form (e.g., voice, modem, and the like), wireless communications media, and the like. For example, the employed communications networks can include one or more wireless communications networks, cellular communications networks, 3 G communications networks, Public Switched Telephone Network (PSTNs), Packet Data Networks (PDNs), the Internet, intranets, a combination thereof, and the like. Accordingly, the devices and subsystems of the exemplary embodiments of FIGS. 4-6 can be implemented on the World Wide Web.

It is to be understood that the devices and subsystems of the exemplary embodiments of FIGS. 4-6 are for exemplary purposes, as many variations of the specific hardware and/or software used to implement the exemplary embodiments are possible, as will be appreciated by those skilled in the relevant art(s). For example, the functionality of one or more of the devices and subsystems of the exemplary embodiments of FIGS. 4-6 can be implemented via one or more programmed computer systems or devices.

To implement such variations as well as other variations, a single computer system can be programmed to perform the special purpose functions of one or more of the devices and subsystems of the exemplary embodiments of FIGS. 4-6. On the other hand, two or more programmed computer systems or devices can be substituted for any one of the devices and subsystems of the exemplary embodiments of FIGS. 4-6. Accordingly, principles and advantages of distributed processing, such as redundancy, replication, and the like, also can be implemented, as desired, to increase the robustness and performance the devices and subsystems of the exemplary embodiments of FIGS. 4-6.

The devices and subsystems of the exemplary embodiments of FIGS. 4-6 can store information relating to various processes described herein. This information can be stored in one or more memories, such as a hard disk, optical disk, magneto-optical disk, RAM, and the like, of the devices and subsystems of the exemplary embodiments of FIGS. 4-6. One or more databases of the devices and subsystems of the exemplary embodiments of FIGS. 4-6 can store the information used to implement the exemplary embodiments of the present invention. The databases can be organized using data structures (e.g., records, tables, arrays, fields, graphs, trees, lists, and the like) included in one or more memories or storage devices listed herein. The processes described with respect to the exemplary embodiments of FIGS. 4-6 can include appropriate data structures for storing data collected and/or generated by the processes of the devices and subsystems of the exemplary embodiments of FIGS. 4-6 in one or more databases thereof.

All or a portion of the devices and subsystems of the exemplary embodiments of FIGS. 4-6 can be conveniently implemented using one or more general purpose computer systems, microprocessors, digital signal processors, microcontrollers, and the like, programmed according to the teachings of the exemplary embodiments of the present invention, as will be appreciated by those skilled in the computer and software arts. Appropriate software can be readily prepared by programmers of ordinary skill based on the teachings of the exemplary embodiments, as will be appreciated by those skilled in the software art. In addition, the devices and subsystems of the exemplary embodiments of FIGS. 4-6 can be implemented by the preparation of application-specific integrated circuits or by interconnecting an appropriate network of conventional component circuits, as will be appreciated by those skilled in the electrical art(s). Thus, the exemplary embodiments are not limited to any specific combination of hardware circuitry and/or software.

Stored on any one or on a combination of computer readable media, the exemplary embodiments of the present invention can include software for controlling the devices and subsystems of the exemplary embodiments of FIGS. 4-6, for driving the devices and subsystems of the exemplary embodiments of FIGS. 4-6, for enabling the devices and subsystems of the exemplary embodiments of FIGS. 4-6 to interact with a human user, and the like. Such software can include, but is not limited to, device drivers, firmware, operating systems, development tools, applications software, and the like. Such computer readable media further can include the computer program product of an embodiment of the present invention for performing all or a portion (if processing is distributed) of the processing performed in implementing the exemplary embodiments of FIGS. 4-6. Computer code devices of the exemplary embodiments of the present invention can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the exemplary embodiments of the present invention can be distributed for better performance, reliability, cost, and the like.

As stated above, the devices and subsystems of the exemplary embodiments of FIGS. 4-6 can include computer readable medium or memories for holding instructions programmed according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

While the present inventions have been described in connection with a number of exemplary embodiments, and implementations, the present inventions are not so limited, but rather cover various modifications, and equivalent arrangements, which fall within the purview of the appended claims.

What is claimed is:

1. A method of treating fluid chromatography data of a specified fluid analysis type, the method comprising:
receiving the fluid chromatography data of a fluid sample which includes at least one fluid component of the specified fluid analysis type from a detector of a fluid analyzer, the received fluid chromatography data comprising signal values as a function of time;
processing the received fluid chromatography data, the processing comprising:
detecting at least one fluid component peak within the signal values for obtaining at least one retention time corresponding to the at least one detected fluid component peak;
identifying the at least one fluid component corresponding to the at least one detected retention time using shape recognition through an artificial neural network preliminarily trained for identifying fluid component peaks of fluid chromatography data of the specified fluid analysis type;
integrating the at least one detected fluid component peak to determine a quantity of the at least one fluid component detected by the detector of the fluid analyzer; and
calculating a fluid sample composition from the at least one identified fluid component and the quantity or quantities of the at least one identified fluid component.

2. The method of claim 1, wherein the processing step further comprises defining a baseline within the signal values.

3. The method of claim 2, wherein the baseline is defined using shape recognition through the artificial neural network.

4. The method of claim 1, wherein the integrating step comprises deconvoluting at least one unresolved fluid component peak.

5. The method of claim 1, wherein the step of detecting at least one fluid component peak comprises:
detecting a peak start on the baseline;
discriminating the at least one fluid component peak from other peaks and noise using a threshold value; and
detecting a peak crest and a peak end of each fluid component peak.

6. The method of claim 4, wherein the deconvoluting step comprises:
calculating a derivative of the at least one unresolved fluid component peak; and
comparing the derivative to a derivative of a resolved fluid component peak.

7. The method of claim 1, further comprising calibrating the detector of the fluid analyzer.

8. The method of claim 1, further comprising reporting the processed fluid chromatography data.

9. A device for processing fluid chromatography data of a fluid sample which includes at least one fluid component of a specified fluid analysis type, the fluid chromatography data comprising signal values as a function of time, the device comprising:
an input to receive the fluid chromatography data from a fluid analyzer;
a peak detection module configured to detect at least one fluid component peak within the signal values for obtaining at least one retention time corresponding to the at least one detected fluid component peak;
a peak integration module configured to integrate the at least one detected fluid component peak;
a fluid component identification module comprising an artificial neural network configured to identify the at least one fluid component corresponding to the at least one detected retention time, the artificial neural network being preliminarily trained for identifying fluid component peaks of fluid chromatography data of the specified fluid analysis type; and
a calculation module configured to calculate a fluid sample composition.

10. The device of claim 9, further comprising a baseline definition module configured to define a baseline within the signal values.

11. The device of claim 9, wherein the peak integration module comprises a peak deconvolution module configured to deconvolute unresolved fluid component peaks.

12. A system for treating fluid chromatography data of a specified fluid analysis type, the system comprising:
a fluid analyzer comprising an injector, at least one separation column, and a detector;
a device for processing fluid chromatography data of a fluid sample which includes at least one fluid component of a specified fluid analysis type, the fluid chromatography data comprising signal values as a function of time, the device further comprising:
an input to receive the fluid chromatography data from a fluid analyzer;
a peak detection module configured to detect at least one fluid component peak within the signal values for obtaining at least one retention time corresponding to the at least one detected fluid component peak;
a peak integration module configured to integrate the at least one detected fluid component peak;
a fluid component identification module comprising an artificial neural network configured to identify the at least one fluid component corresponding to the at least one detected retention time, the artificial neural network being preliminarily trained for identifying fluid component peaks of fluid chromatography data of the specified fluid analysis type; and
a calculation module configured to calculate a fluid sample composition.

13. The system of claim 12, further comprising a calibration module configured to calibrate the detector of the fluid analyzer.

14. The system of claim 12, further comprising a reporting module configured to report the processed fluid chromatography data.

15. The system of claim 12, wherein the device further comprises a baseline definition module configured to define a baseline within the signal values.

16. The system of claim 12, wherein the peak integration module comprises a peak deconvolution module configured to deconvolute unresolved fluid component peaks.

17. A training method for an artificial neural network in a fluid component identification module of a device for processing fluid chromatography data of a fluid sample of a specified fluid analysis type, the artificial neural network comprising a set of weights to be optimized, the training method comprising:
preparing a set of training chromatography data of at least one fluid sample which includes at least one determined component of the specified fluid analysis type, the training chromatography data comprising signal values as a function of time;
creating at least one input vector of selected time values for the set of training chromatography data; and
inputting the at least one input vector into the artificial neural network to calculate the optimized set of weights corresponding to the specified fluid analysis type.

18. The method of clam 17, wherein the selected time values correspond to fluid component peak crest signal values.

19. A computer program product for treating fluid chromatography data of a specified fluid analysis type and including one or more computer readable instructions embedded on a computer readable medium and configured to cause one or more computer processors to perform the steps of:
receiving the fluid chromatography data of a fluid sample which includes at least one fluid component of the specified fluid analysis type from a detector of a fluid analyzer, the received fluid chromatography data comprising signal values as a function of time;
processing the received fluid chromatography data, the processing comprising:
detecting at least one fluid component peak within the signal values for obtaining at least one retention time corresponding to the at least one detected fluid component peak;
identifying the at least one fluid component corresponding to the at least one detected retention time using shape recognition through an artificial neural network preliminarily trained for identifying fluid component peaks of fluid chromatography data of the specified fluid analysis type;
integrating the at least one detected fluid component peak to determine a quantity of the at least one fluid component detected by the detector of the fluid analyzer; and
calculating a fluid sample composition from the at least one identified fluid component and the quantity or quantities of the at least one identified fluid component.

20. A computer program product for an artificial neural network having a set of weights to be optimized for fluid component identification for processing fluid chromatography data of a fluid sample of a specified fluid analysis type, and including one or more computer readable instructions embedded on a computer readable medium and configured to cause one or more computer processors to perform the steps of:
preparing a set of training chromatography data of at least one fluid sample which includes at least one determined component of the specified fluid analysis type, the training chromatography data comprising signal values as a function of time;
creating at least one input vector of selected time values for the set of training chromatography data; and
inputting the at least one input vector into the artificial neural network to calculate the optimized set of weights corresponding to the specified fluid analysis type.
